(19) United States
(12) Patent Application Publication
(10) Pub. No.: US 2015/0220481 A1
(43) Pub. Date: Aug. 6, 2015

(54) ARITHMETIC PROCESSING APPARATUS, INFORMATION PROCESSING APPARATUS, AND CONTROL METHOD OF ARITHMETIC PROCESSING APPARATUS

(71) Applicant: FUJITSU LIMITED, Kawasaki-shi (JP)

(72) Inventor: Teruo Tanimoto, Kawasaki (JP)

(21) Appl. No.: 14/576,918

(22) Filed: Dec. 19, 2014

(30) Foreign Application Priority Data
Feb. 3, 2014 (JP) 2014-018575

(51) Int. Cl. G06F 15/173; G06F 12/02; G06F 12/08

(52) U.S. Cl. CPC G06F 15/17331; G06F 12/0864; G06F 12/023; G06F 2212/6032; G06F 2212/657

(57) ABSTRACT

A processor core executes an arithmetic processing, and allocates an area in a memory with respect to a process of reading data and writing data. An MMU receives a use request for the memory form the processor core 1 and performs the process on the memory by using a first area of the memory allocated by the processor core. An RDMA module receives an instruction to perform a data transfer process between the memory and another memory from the processor core, requests, when the area for the data transfer has not been allocated, the processor core to execute the allocation, and performs the data transfer process by using a second area that is allocated by the processor core.

### CROSS-REFERENCE TO RELATED APPLICATION

This application is based upon and claims the benefit of priority of the prior Japanese Patent Application No. 2014-018575, filed on Feb. 3, 2014, the entire contents of which are incorporated herein by reference.

### FIELD

The embodiments discussed herein are related to an arithmetic processing apparatus, an information processing apparatus, and a control method of the arithmetic processing apparatus.

### BACKGROUND

With high-speed networks, distributed resources can be more easily used and thus there is a growing importance of a direct access from a device located in a predetermined node in a computer network to a remote memory located in another node. In addition, as the transmission speed between arithmetic processing apparatuses is increased, the effect of the performance of communication time between the arithmetic processing apparatuses exerted on the overall process performed by the arithmetic processing apparatuses is increased.

Accordingly, a Remote Direct Memory Access (RDMA) used in the High Performance Computing (HPC) field is increasingly used in databases or network file systems. The RDMA is a technology of directly exchanging data between memories in two devices via a network, i.e., without using a central processing unit (CPU) that is an arithmetic processing apparatus.

By using an RDMA for data transfer, a buffer between an application and an operating system does not need to be copied and thus it is possible to speed up communication and the throughput between arithmetic processing apparatuses. Furthermore, with RDMA, because it is possible to minimize intervention of an operating system (OS), a context switch does not occur and thus a low delay can be implemented.

For example, in an RDMA, the following process is performed. Namely, a first node reserves a transfer area in a memory, locks the reserved transfer area, and disables a page out process. Then, when information in the transfer area is transmitted to a second node, the second node can directly read and write data from and to the specified transfer area.

As the RDMA technology described above, there is a conventional technology in which a processor is subjected to interrupt when a cache miss occurs in an address translation buffer and then an address element is set in a buffer. Furthermore, there is a conventional technology in which a memory management unit (MMU), a translation lookaside buffer (TLB), and a synchronous dynamic random access memory (SDRAM) are installed in a network interface controller (NIC) and area registration is omitted.

Patent Document 1: Japanese Laid-open Patent Publication No. 05-173930

Non-Patent Document 1: The Quadrics Network (QsNet): High-Performance Clustering Technology, Fabrizio Petrini, Wu-chun Feng, Adolfy Hoisie, Salvador Coll, and Eitan Frachtenberg, Computer & Computational Sciences Division Los Alamos National Laboratory

However, if a transfer area in a memory is locked in order to perform an RDMA, an area in the memory continues to be occupied due to an RDMA process. Consequently, if an amount of the RDMA process is increased, the transfer area registered for the RDMA suppresses the memory resources. Furthermore, if a lock is performed every time when an RDMA is performed, the processing load of a CPU is increased.

Furthermore, in the conventional technology in which a processor is subjected to interrupt when a cache miss occurs in an address translation buffer, a reduction in a locked transfer area is not considered; therefore, it is difficult to solve the suppression of the memory resources. Furthermore, in the conventional technology in which an MMU, a TLB, and an SDRAM are installed in an NIC, because each of an OS and an NIC has a page table that indicates a memory area, the processing load is applied on a CPU in order to maintain the consistency of the OS and the NIC.

### SUMMARY

According to an aspect of an embodiment, an arithmetic processing apparatus includes: an arithmetic processing unit that executes an arithmetic processing, that allocates an area of first main storage with respect to a process of reading data and writing data, and that creates allocation information indicating the allocated area; a memory management unit that performs, by receiving a use request for the first main storage from the arithmetic processing unit, a data management process on the first main storage by using a first area that is indicated by the allocation information; and a data transfer control unit that requests, by receiving an instruction to perform a data transfer process between the first main storage and a second main storage from the arithmetic processing unit, when an area for the data transfer has not been allocated, the arithmetic processing unit to execute the allocation and that performs the data transfer process by using a second area indicated by the allocation information that is created by the arithmetic processing unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating the system configuration of an example of an information processing system that executes an RDMA;

FIG. 2 is a block diagram illustrating the data transfer function of the RDMA performed by a CPU and a memory;

FIG. 3 is a schematic diagram illustrating an example of an address space table;

FIG. 4 is a schematic diagram illustrating an example of the format of a page table;

FIG. 5 is a flowchart illustrating the flow of a registration process performed in a user application area in the memory;

FIG. 6 is a flowchart illustrating the flow of a process performed by an information processing apparatus that executes RDMA transmission;

FIG. 7 is a flowchart illustrating the flow of a process performed by the information processing apparatus that receives data by using an RDMA;

FIG. 8 is a flowchart illustrating the flow of a data transmission process performed by an RDMA module;

FIG. 9 is a flowchart illustrating the flow of a data reception process performed by the RDMA module;

FIG. 10 is a schematic diagram illustrating overhead due to page allocation when data is transferred by using the RDMA according to a first embodiment;

FIG. 11 is a block diagram illustrating an information processing apparatus according to a modification of the first embodiment;

FIG. 12 is a block diagram illustrating an information processing apparatus according to a second embodiment;

FIG. 13 is a flowchart illustrating the flow of an area registration process performed when a page lock is used;

FIG. 14 is a flowchart illustrating the flow of a process performed by the information processing apparatus that executes RDMA transmission by using a page lock;

FIG. 15 is a flowchart illustrating the flow of a process performed by the information processing apparatus that receives, by using a page lock, data by using an RDMA;

FIG. 16 is a flowchart illustrating the flow of a data transmission process performed by the RDMA module when a page lock is used; and

FIG. 17 is a flowchart illustrating the flow of a process of receiving data performed by the RDMA module when a page lock is used.

### DESCRIPTION OF EMBODIMENTS

Preferred embodiments of the present invention will be explained with reference to accompanying drawings. The arithmetic processing apparatus, the information processing apparatus, and the control method of the arithmetic processing apparatus disclosed in the present invention are not limited to the embodiments described below.

### [a] First Embodiment

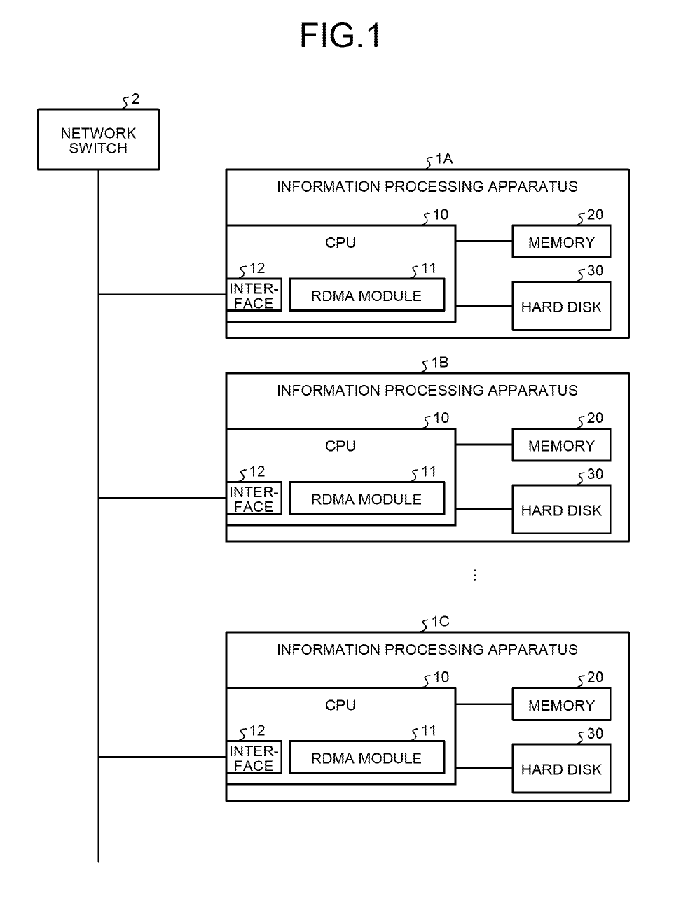

FIG. 1 is a schematic diagram illustrating the system configuration of an example of an information processing system that executes an RDMA. The information processing system that executes the RDMA includes information processing apparatuses 1A to 1C and a network switch.

Each of the information processing apparatuses 1A to 1C is connected to the network switch 2. Furthermore, the information processing apparatuses 1A to 1C can send and receive data each other via the network switch 2. In a description below, the information processing apparatuses 1A to 1C are simply referred to as an “information processing apparatus 1” as long as the information processing apparatuses 1A to 1C need not be distinguished in the first embodiment.

Each of the information processing apparatuses 1A to 1C includes a CPU 10, a memory 20, and a hard disk 30.

The hard disk 30 stores therein various programs, such as applications.

The CPU 10 is connected to the memory 20 and the hard disk 30 by buses. The CPU 10 reads and writes data from and to the memory 20 and the hard disk 30 via the buses. Then, the CPU 10 reads various programs stored in the hard disk 30, loads the read program in the memory 20, and executes the program.

Furthermore, the CPU 10 includes an RDMA module 11 and an input/output (I/O) interface 12. In FIG. 1, the I/O interface 12 is simply illustrated by “I/O”.

The RDMA module 11 reads or writes data from and to the memory 20 when data transfer is performed by using an RDMA. Furthermore, in the data transfer by using the RDMA, the RDMA module 11 transmits the data read from the memory 20 to the other information processing apparatus 1 via the I/O interface 12. Furthermore, in the data transfer by using the RDMA, the RDMA module 11 receives data from the other information processing apparatus 1 via the I/O interface 12. Then, the RDMA module 11 stores the received data in the memory 20. In the following, the function of data transfer performed by using an RDMA by the information processing apparatus 1 according to the first embodiment will be described in detail.

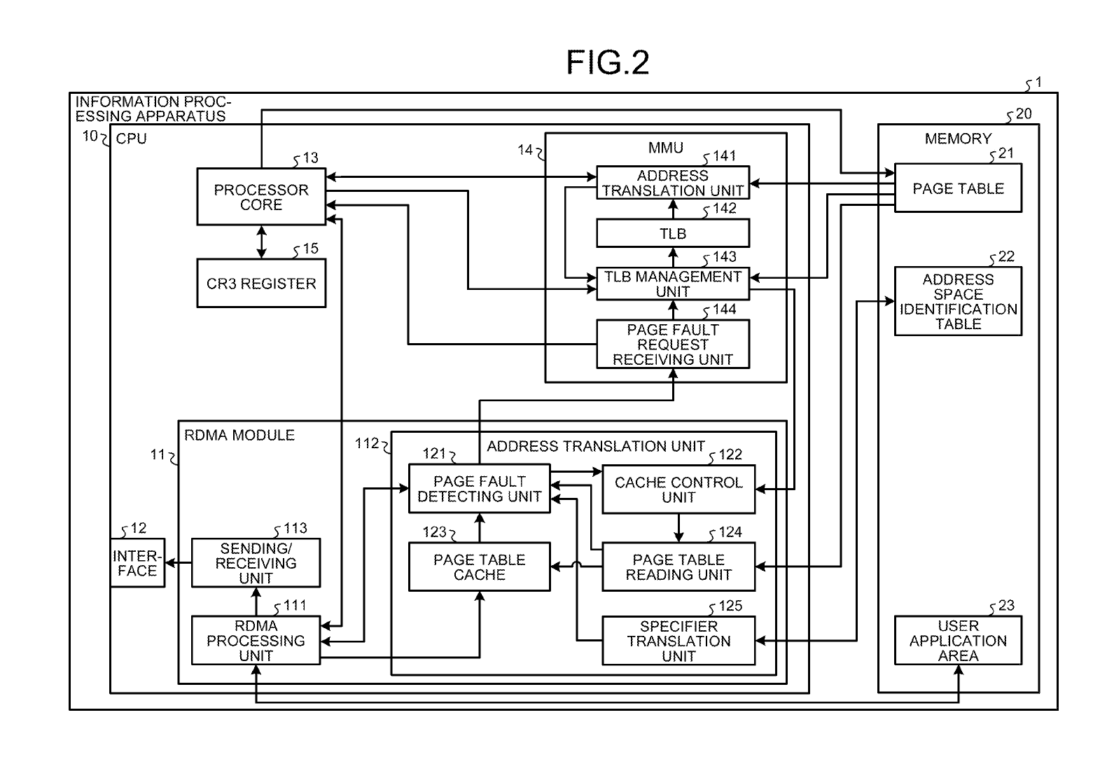

FIG. 2 is a block diagram illustrating the data transfer function of the RDMA performed by a CPU and a memory. For convenience of explanation, FIG. 2 mainly illustrates the function used for the data transfer performed by using an RDMA and does not illustrate another function.

The memory 20 includes a page table 21 and an address space identification table 22. Furthermore, when the memory 20 performs data transfer by using an RDMA, the memory 20 reserves a user application area 23 in the memory 20. The memory 20 mentioned here corresponds to an example of “first main storage”. Furthermore, when the data transfer by using an RDMA is performed by the subject memory 20 in the information processing apparatus 1, the memory 20 in the other information processing apparatus 1 that functions as the transmission destination or the transmission source corresponds to an example of a “second main storage”.

The page table 21 is a translation table that is used to translate a virtual address to a physical address. Each entry that indicates a combination of a virtual address and a physical address stored in the page table 21 is referred to as a page table entry (PTE). The page table 21 is rewritten, such as an update, by the OS executed by a processor core 13. The page table 21 mentioned here corresponds to an example of “allocation information”.

The address space identification table 22 is a table that indicates the association between an area specifier and a control register (CR) 3 value. The area specifier mentioned here is identification information for specifying a transfer area for data transfer performed by using an RDMA. The CR3 value mentioned here is an identifier that indicates address space and that is used to determine a page middle directory (sometimes referred to as a “page directory”) associated with each application. The page middle directory is one of pieces of information used to specify a physical address that is associated with a virtual address in the page table 21.

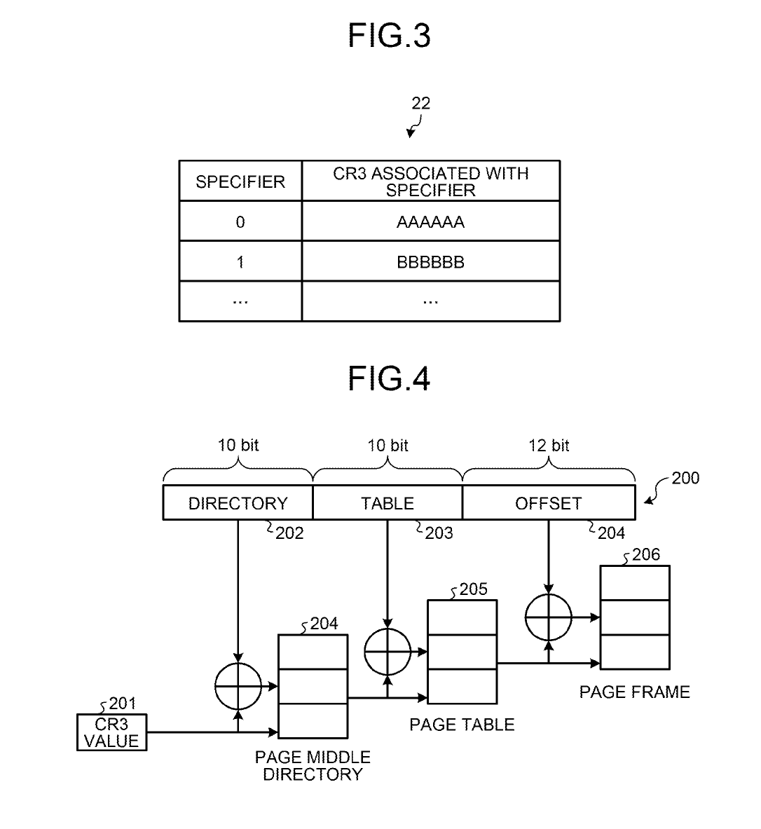

The address space identification table 22 is a table illustrated in, for example, FIG. 3. FIG. 3 is a schematic diagram illustrating an example of an address space table. As illustrated in FIG. 3, the CR3 value is registered in the address space identification table 22 by being associated with each of the area specifiers.

The user application area 23 is a storing area for data that is allocated for each application. An area used for data transfer is reserved in the user application area 23 when the processor core 13, which will be described later, allocates a physical address that is associated with a virtual address used for the data transfer performed by using an RDMA.

The CPU 10 includes, in addition to the RDMA module 11 and the I/O interface 12, the processor core 13 that is an arithmetic processing unit, an MMU 14, and a CR3 register 15.

The CR3 register 15 holds a CR3 value that is associated with each application.

The processor core 13 executes an application. Furthermore, if the memory 20 is used by an executed application for other than an RDMA, the processor core 13 acquires the CR3 value associated with that application from the CR3 register 15. Then, the processor core 13 transmits the acquired CR3 value to an address translation unit 141 together with the CR3 value by which an address translation request for a virtual address specified by the application has been acquired.

Then, when the address translation unit 141 acquires the physical address that is associated with the virtual address, the processor core 13 acquires, from the address translation unit 141, a physical address as a response to the address translation request. Then, the processor core 13 performs a process of reading and writing data, performed by the application, from and to the memory 20 by using the acquired physical address.

In contrast, if the address translation unit 141 does not acquire the physical address associated with the virtual address, the processor core 13 receives, from the address translation unit 141, a notification of a page fault as a response to the address translation request. In this case, the processor core 13 enters an interrupt into the process performed by the OS. Then, the processor core 13 uses the OS to allocate a physical address associated with a virtual address that is targeted for an address translation request. The processor core 13 performs this allocation for each page. Consequently, the processor core 13 stores, in an associated manner, the virtual address targeted for the address translation request and the allocated physical address in the page table 21. Then, the processor core 13 acquires the physical address associated with the virtual address that is targeted for the address translation request from the address translation unit 141 and performs a process of reading and writing data that are performed by the acquired application.

Furthermore, if data transmission that uses an RDMA is performed, the processor core 13 acquires an instruction to perform the data transmission by using the RDMA from the application. The virtual address of the data to be transmitted is included in the instruction to perform the data transmission by using the RDMA from the application. In a description below, the data transmission performed by using an RDMA is referred to as “RDMA transmission”. The processor core 13 acquires an area specifier of the user application area 23 registered with respect to the application that instructs the RDMA transmission. Then, the processor core 13 outputs the instruction to perform the RDMA transmission to an RDMA processing unit 111, which will be described later, together with the acquired area specifier. Thereafter, if the RDMA transmission has been completed, the processor core 13 receives a completion notification from the RDMA processing unit 111.

Furthermore, if the RDMA processing unit 111 does not acquire a physical address associated with a virtual address, the processor core 13 acquires a notification of a page fault from a page fault request receiving unit 144 in the MMU 14, which will be described later. Then, the processor core 13 interrupts the process performed by the OS. Then, the processor core 13 allocates, by using the OS, a physical address with respect to a virtual address of the data that is targeted for the RDMA transmission. The processor core 13 performs this allocation for each page. Consequently, the processor core 13 stores, in an associated manner in the page table 21, the virtual address of the data targeted for the RDMA transmission and the allocated physical address.

Furthermore, the processor core 13 notifies a TLB management unit 143, which will be described later, of a change in the page table 21 due to the OS related to, for example, the page out. The page out mentioned here indicates a process in which a page that has a low degree of need and that is not used for a long time in the memory 20 is written in the hard disk 30 (see FIG. 1) and is then deleted from the memory 20.

The MMU 14 includes the address translation unit 141, a TLB 142, the TLB management unit 143, and the page fault request receiving unit 144. The MMU 14 mentioned here corresponds to an example of a “memory management unit”.

The TLB 142 is a cache that is used to speed up translation from a virtual address to a physical address. The TLB 142 stores therein some pieces of the association information related to the virtual addresses and the physical addresses registered in the page table 21. Namely, the TLB 142 stores therein a subset of the page table 21. The TLB 142 is formed by using the same format as that of the page table 21. In a description below, each piece of the association information related to a virtual address and a physical address stored in the TLB 142 is also referred to as a page table entry.

The address translation unit 141 receives an address translation request from the processor core 13 together with the CR3 value. Then, the address translation unit 141 determines, by using the received CR3 value, whether the physical address associated with the virtual address specified by the address translation request is present in the TLB 142.

In the following, acquiring of a physical address associated with a virtual address performed by the address translation unit 141 will be described with reference to FIG. 4. FIG. 4 is a schematic diagram illustrating an example of the format of a page table. Here, a description will be given below in a case in which the address translation unit 141 receives a translation request of a virtual address 200 together with a CR3 value 201. Here, a description will be given below in a case in which the address translation unit 141 determines whether a specified page table entry is stored in the TLB 142. Furthermore, because the TLB 142 and the page table 21 have the same format, the address translation unit 141 also searches the page table 21 by using the same process as that used for searching the TLB 142.

The page table 21 and the TLB 142 each include, for example, as illustrated in FIG. 4, a multiple-stage table that includes a page middle directory 204, a page table 205, and a page frame 206.

The address translation unit 141 selects the page middle directory 204 associated with the received CR3 value from the TLB 142. Then, the address translation unit 141 performs an arithmetical operation by using directory information 202 and the CR3 value 201 represented by upper 10 bits of the virtual address 200 and then obtains an address. Then, the address translation unit 141 acquires a page table entry stored in the obtained address in the page middle directory 204.

Then, the address translation unit 141 selects, from the TLB 142, the page table 205 that is associated with the page table entry and that has been acquired from the page middle directory 204. Then, the address translation unit 141 performs an arithmetical operation by using a table information 203 that is represented by a value of 11 to 20 bits of the virtual address 200 and by using the acquired page table entry and then obtains an address. Then, the address translation unit 141 acquires the page table entry stored in the obtained address in the page table 205.

Then, the address translation unit 141 selects, from the TLB 142, the page frame 206 associated with the page table entry acquired from the page table 205. Then, the address translation unit 141 acquires a physical address that is stored in the address, in the selected page frame 206, that is represented by the page middle directory 204 with a value of remaining 12 bits in the virtual address 200. The physical address that is acquired last time is the physical address associated with the virtual address requested by the address translation request. If the physical address can be acquired, the address translation unit 141 can determine that the physical address associated with the virtual address specified by the address translation request is present in the TLB 142.

A description will be continuously given by referring back to FIG. 2. If a page table entry that is associated with the specified virtual address is present in the TLB 142, the address translation unit 141 acquires the physical address that is associated with the specified virtual address from the TLB 142. Then, the address translation unit 141 transmits the acquired physical address to the processor core 13 as a response to the address translation request.

In contrast, if a page table entry associated with the specified virtual address is not present in the TLB 142, the address translation unit 141 notifies the TLB management unit 143 that a cache miss has occurred in the TLB 142 together with a virtual address that is targeted for the cache miss. Furthermore, the address translation unit 141 determines whether a page table entry associated with the virtual address that is specified by the address translation request is stored in the page table 21. At this point, the address translation unit 141 performs the same search process as that performed on the page table entry in the TLB 142 described above on the page table 21 and searches for a page table entry.

If the page table entry associated with the specified virtual address is present in the page table 21, the address translation unit 141 acquires the physical address that is associated with the specified virtual address from the page table 21. Then, the address translation unit 141 transmits the acquired physical address to the processor core 13 as a response to the address translation request.

In contrast, if the page table entry associated with the specified virtual address is not present in the page table 21, the address translation unit 141 notifies the processor core 13 that a page fault has occurred. Thereafter, if the page table 21 is updated, the address translation unit 141 acquires the physical address associated with the specified virtual address from the page table 21. Then, the address translation unit 141 transmits the acquired physical address to the processor core 13 as a response to the address translation request.

A TLB management unit 43 receives a notification from the address translation unit 141 indicating that a cache miss has occurred in the TLB 142. Then, the TLB management unit 43 determines whether the TLB 142 is to be updated. If an update is performed, the TLB management unit 143 waits for an update of the page table 21. Then, if the page table 21 has been updated, the TLB management unit 43 acquires, from the page table 21, the page table entry that is associated with the virtual address targeted for the cache miss. Then, the TLB management unit 43 stores the acquired page table entry in the TLB 142 and updates the TLB 142.

Furthermore, the TLB management unit 43 acquires a notification from the processor core 13 indicating that a page table has been changed by using the page out or the like. The TLB management unit 43 acquires the page table entry stored in the TLB 142 from the page table 21. Then, the TLB management unit 43 stores the acquired page table entry in the TLB 142 and then updates the TLB 142.

The page fault request receiving unit 144 receives a request for a notification of the page fault from a page fault detecting unit 121 in the RDMA module 11, which will be described later. Then, the page fault request receiving unit 144 notifies the processor core 13 that the page fault has occurred.

The I/O interface 12 is a communication interface between the RDMA module 11 and the RDMA module 11 in the other information processing apparatus 1.

The RDMA module 11 includes the RDMA processing unit 111, an address translation unit 112, and a sending/receiving unit 113. This RDMA module 11 mentioned here corresponds to an example of a “data transfer control unit”.

The RDMA processing unit 111 receives an instruction of the RDMA transmission from the processor core 13 together with an area specifier. Then, the RDMA processing unit 111 transmits the address translation request for a virtual address of the data that is targeted for the RDMA transmission to the page fault detecting unit 121 together with the received area specifier.

Then, the RDMA processing unit 111 acquires, from the page fault detecting unit 121, the physical address that is associated with the virtual address specified by the address translation request. Then, the RDMA processing unit 111 reads data from the physical address that is acquired from the user application area 23. Then, the RDMA processing unit 111 transmits the read data to the sending/receiving unit 113. Thereafter, when the RDMA processing unit 111 receives an acknowledgement (ACK) from the information processing apparatus 1 that is the transmission destination of the data, the RDMA processing unit 111 transmits a completion notification of the RDMA transmission to the processor core 13.

Furthermore, the RDMA processing unit 111 receives, from the sending/receiving unit 113, the data that has been transmitted from the other information processing apparatus 1 by using an RDMA. Then, the RDMA processing unit 111 acquires a virtual address of the writing destination of the data and an area specifier of the application of the transmission source of the data from the reception data. Then, the RDMA processing unit 111 transmits, to the page fault detecting unit 121 together with the received area specifier, an instruction to perform address translation of the virtual address of the writing destination of the data.

Then, the RDMA processing unit 111 acquires the physical address that is associated with the virtual address of the writing destination of the data from the page fault detecting unit 121. Then, the RDMA processing unit 111 writes the data into the acquired physical address in the user application area 23. When the writing of the data has been completed, the RDMA processing unit 111 transmits an ACK to the information processing apparatus 1 that is the transmission source of the data. Then, the RDMA processing unit 111 transmits a completion notification to the processor core 13.

The address translation unit 112 includes the page fault detecting unit 121, a cache control unit 122, a page table cache 123, a page table reading unit 124, and a specifier translation unit 125.

The page table cache 123 stores therein some pieces of the association information related to the virtual addresses and the physical addresses used for the RDMA transmission. The association information that is related to the virtual address and the physical address stored in the page table cache 123 is a subset of the page table 21. Namely, the page table cache 123 retains the association information related to a virtual address and a physical address in the same format as that used in the page table 21 and the TLB 142. In a description below, the association information that is related to the virtual address and the physical address used for the RDMA transmission and that is stored in the page table cache 123 is also referred to as a “page table entry”.

When data is sent or received by using an RDMA, the page fault detecting unit 121 receives, from the RDMA processing unit 111, an address translation request for a virtual address and an area specifier of the application that specifies the RDMA transmission.

The page fault detecting unit 121 instructs the specifier translation unit 125 to translate the received area specifier to the CR3 value. Then, the page fault detecting unit 121 acquires the CR3 value associated with the acquired area specifier from the specifier translation unit 125.

Then, by using the acquired CR3 value, the page fault detecting unit 121 determines whether the page table entry associated with the virtual address requested by the address translation request is present in the page table cache 123.

At this point, as described above, each of the page table cache 123, the page table 21, and the TLB 142 stores a page table entry by using the same format. Accordingly, the page fault detecting unit 121 searches the page table cache 123 for a page table entry by using the same search process as that performed on the page table entry in the TLB 142 described above.

If the page table entry associated with the virtual address requested by the address translation request is present in the page table cache 123, the page fault detecting unit 121 acquires the physical address associated with that virtual address from the page table cache 123. Then, the page fault detecting unit 121 transmits the acquired physical address to the RDMA processing unit 111 as a response to the address translation request.

In contrast, if the page table entry associated with the virtual address of the data targeted for the RDMA transmission is not present in the page table cache 123, the page fault detecting unit 121 determines that a cache miss has occurred. Then, the page fault detecting unit 121 instructs the cache control unit 122 to acquire information from the page table 21.

Thereafter, when the page fault detecting unit 121 acquires the physical address associated with the virtual address from the page table reading unit 124, the page fault detecting unit 121 transmits the acquired physical address to the RDMA processing unit 111 as a response to the address translation request.

In contrast, if the physical address associated with the virtual address is not transmitted from the page table reading unit 124, the page fault detecting unit 121 determines that a physical address has not been allocated to the virtual address that is associated with the address translation request. Namely, the page fault detecting unit 121 determines that a page has not been allocated to the virtual address requested by the address translation request.

If a page has not been allocated, the page fault detecting unit 121 transmits a notification request for a page fault to the page fault request receiving unit 144. Furthermore, the page fault detecting unit 121 instructs the page table reading unit 124 to update the page table entry. Thereafter, when the page table cache 123 has been updated, the page fault detecting unit 121 acquires, from the page table cache 123, the physical address that is associated with the virtual address requested by the address translation request. Then, the page fault detecting unit 121 transmits the acquired physical address to the RDMA processing unit 111 as the response to the address translation request.

The cache control unit 122 receives a change notification of the page table 21 due to the page out or the like from the TLB management unit 143. Then, the cache control unit 122 instructs the page table reading unit 124 to update the page table entries stored in the page table cache 123.

Furthermore, the cache control unit 122 receives, from the page fault detecting unit 121, an instruction to acquire information from the page table 21. Then, the cache control unit 122 instructs the page table reading unit 124 to read the page table entry that is associated with the virtual address specified by the address translation request.

The page table reading unit 124 receives an instruction to update the page table entries from the cache control unit 122. In this case, the page table reading unit 124 acquires the latest information on the page table entry stored in the page table cache 123 from the page table 21. Then, the page table reading unit 124 adds the acquired page table entry to the page table cache 123. Furthermore, the page table reading unit 124 transmits the physical address stored in the acquired page table entry to the page fault detecting unit 121.

Furthermore, the page table reading unit 124 receives, from the cache control unit 122, an instruction to update the page table entry that is associated with the virtual address requested by the address translation request. In this case, if the page table entry associated with the virtual address requested by the address translation request is present in the page table 21, the page table reading unit 124 acquires that page table entry. Then, the page table reading unit 124 adds the acquired page table entry to the page table cache 123. Furthermore, the page table reading unit 124 transmits the physical address that is stored in the acquired page table entry to the page fault detecting unit 121.

In contrast, if the page table entry that is associated with the virtual address requested by the address translation request is not present in the page table 21, the page table reading unit 124 performs the following process. First, the page table reading unit 124 waits, while monitoring the page table 21, until the page table entry that is associated with the virtual address requested by the address translation request is added and the page table 21 is updated. Then, the page table reading unit 124 acquires the page table entry. Then, the page table reading unit 124 adds the acquired page table entry to the page table cache 123.

The specifier translation unit 125 receives a translation request for an area specifier from the page fault detecting unit 121. Then, the specifier translation unit 125 acquires the CR3 value that is associated with the area specifier specified by the translation request from the address space identification table 22. Then, the specifier translation unit 125 transmits the acquired CR3 value to the page fault detecting unit 121.

If RDMA transmission is performed, the sending/receiving unit 113 receives data to be transmitted from the RDMA processing unit 111. Then, the sending/receiving unit 113 transmits the received data to the information processing apparatus 1 that is the transmission destination of the RDMA transmission via the I/O interface 12.

Furthermore, if data transmitted by using an RDMA is received, the sending/receiving unit 113 receives the data via the I/O interface 12. Then, the sending/receiving unit 113 transmits the received data to the RDMA processing unit 111.

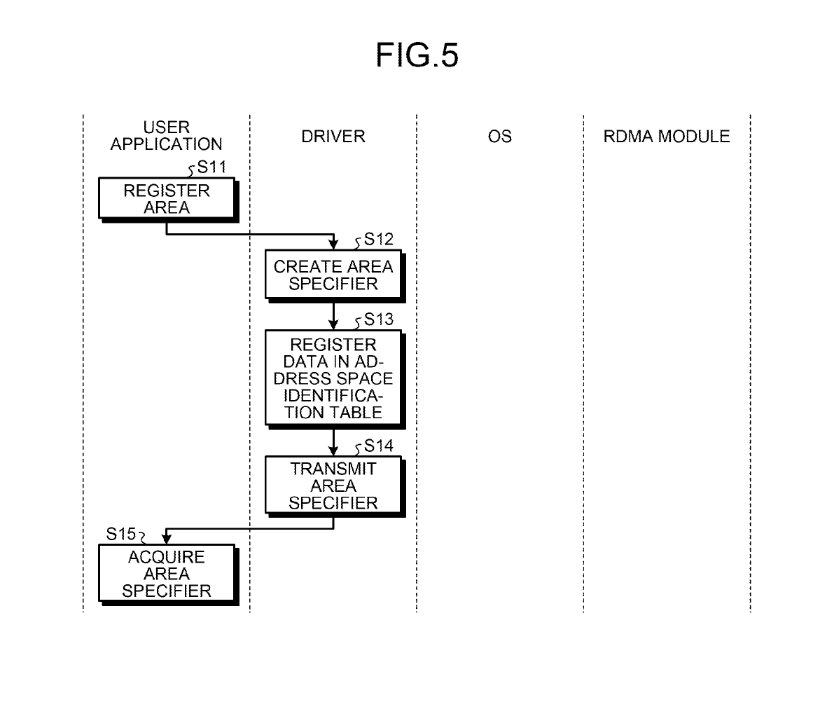

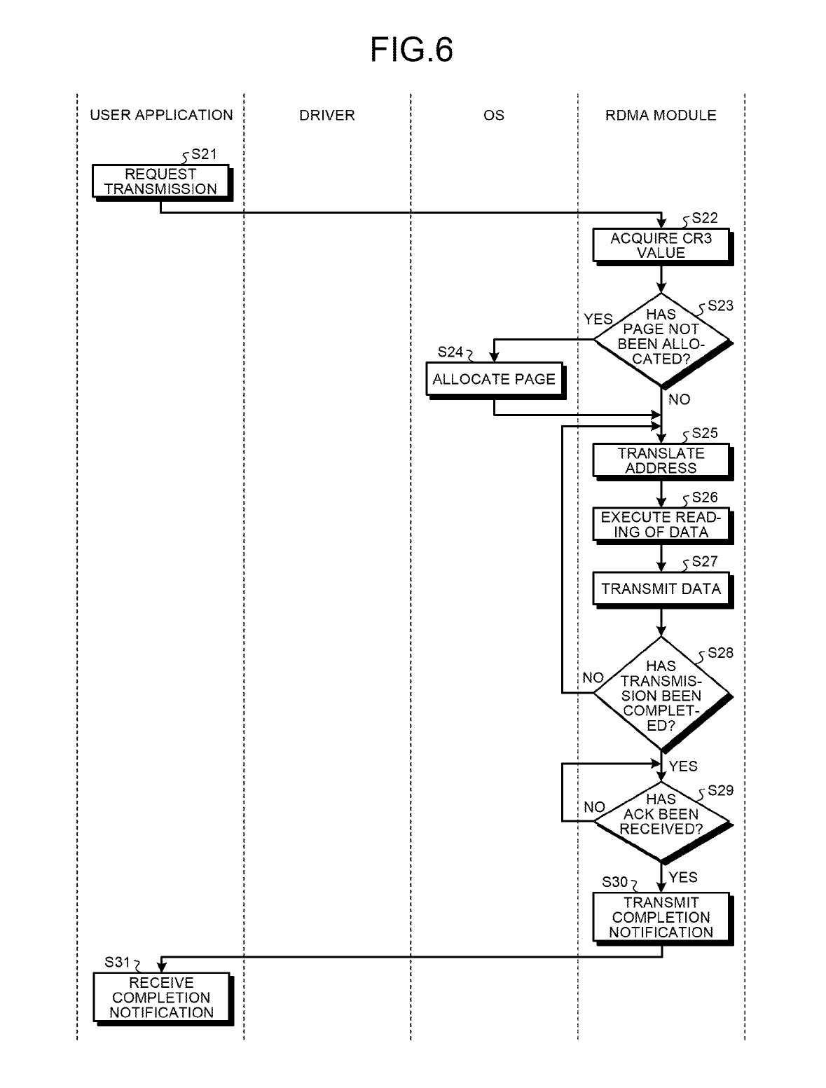

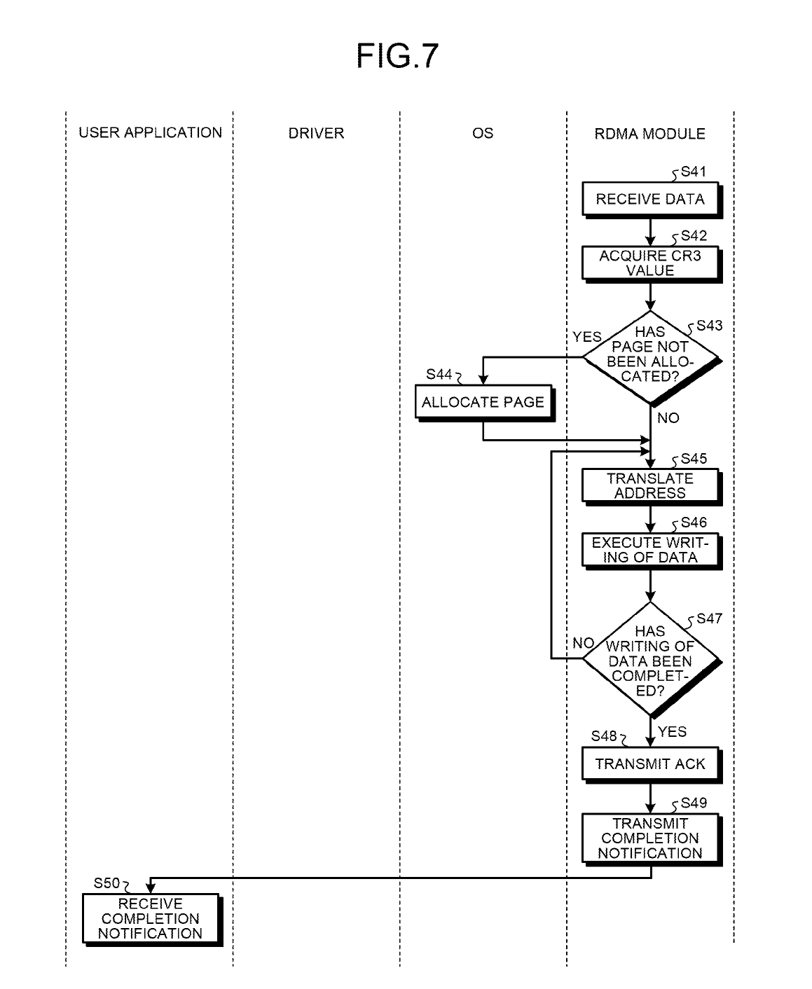

In the following, the flow of a registration process performed by the user application area 23 in the memory 20 will be described with reference to FIG. 5. FIG. 5 is a flowchart illustrating the flow of a registration process performed in a user application area in the memory. The component illustrated in the upper portion of each of the blocks in FIG. 5 indicates the subject of the operation in that block. However, in FIG. 5, for convenience, software executed by the processor core 13 is represented as the subject of the operation. Specifically, in practice, the subject of the operation as hardware associated with each of the pieces of the software is the processor core 13. The same setting described above is also applied to the setting illustrated in FIGS. 6 and 7.

The user application instructs the driver to register an area (Step S11).

The driver receives an instruction to register an area from the user application and then registers the user application area 23 in the memory 20 in order to be used by the user application. Then, the driver creates an area specifier that is used to uniquely identify the registered user application area 23 (Step S12).

Then, the driver associates the created area specifier with the CR3 value that is allocated to the user application that instructs to register the area and then registers the associated data in the address space identification table 22 in the memory 20 (Step S13).

Then, the driver transmits the created area specifier to the user application that is instructed to register the area (Step S14).

The user application acquires the area specifier transmitted from the driver (Step S15).

At this point, in the registration process performed in the user application area 23 in the memory 20 illustrated in FIG. 5, each of the OS and the RDMA module does not perform a process.

In the following, the flow of the process performed by the information processing apparatus 1 that executes RDMA transmission will be described with reference to FIG. 6. FIG. 6 is a flowchart illustrating the flow of a process performed by an information processing apparatus that executes RDMA transmission.

The user application transmits a transmission request for the transmission performed by using an RDMA to the RDMA module 11 (Step S21).

The RDMA module 11 receives a transmission request for the transmission performed by using the RDMA from the user application. Then, the RDMA module 11 acquires an area specifier of the user application area 23 added to a transmission request. Thereafter, the RDMA module 11 acquires the CR3 value associated with the acquired area specifier from the address space identification table 22 (Step S22).

Then, the RDMA module 11 determines, by using the acquired CR3 value, whether a physical address has not been allocated to the virtual address specified by the transmission request, i.e., whether a page has not been allocated (Step S23). The process of determining whether a page has not been allocated will be described in detail later.

If a page has not been allocated (Yes at Step S23), the RDMA module 11 notifies the OS via the MMU 14 that a page fault has been occurred. In response to the occurrence of the page fault, the OS performs an interrupt and performs page allocation in which a physical address is allocated to a virtual address (Step S24). Then, the OS registers the association information related to the virtual address and the physical address in the page table 21. When the page table 21 is updated, the RDMA module 11 receives an update notification from the MMU 14. Then, the RDMA module 11 acquires the association information related to the association between the virtual address specified by the transmission request and the physical address from the page table 21 and stores the association information in the page table cache 123.

If a page has been already allocated (No at Step S23) or after the process at Step S24 has been performed, the RDMA module 11 performs address translation in which the virtual address specified by the transmission request is translated to the physical address (Step S25).

Then, the RDMA module 11 reads the data stored in the acquired physical address in the user application area 23 (Step S26).

Thereafter, the RDMA module 11 transmits the read data to the information processing apparatus 1 that is the destination of the transmission performed by using the RDMA (Step S27).

Then, the RDMA module 11 determines whether data transmission performed by using an RDMA has been completed (Step S28). If data that has not been transmitted is present (No at Step S28), the RDMA module 11 returns to Step S25.

In contrast, if data has been transmitted (Yes at Step S28), the RDMA module 11 determines whether an ACK is received from the information processing apparatus 1 that is the transmission destination (Step S29). If an ACK has not been received (No at Step S29), the RDMA module 11 waits until an ACK is received.

In contrast, an ACK has been received (Yes at Step S29), the RDMA module 11 transmits a completion notification of the RDMA transmission to the application (Step S30).

The application receives the completion notification of the RDMA transmission sent from the RDMA module 11 (Step S31) and ends the process of the RDMA transmission.

In the following, the flow of the process performed by the information processing apparatus 1 that receives data by using an RDMA will be described with reference to FIG. 7. FIG. 7 is a flowchart illustrating the flow of a process performed by the information processing apparatus that receives data by using an RDMA.

The RDMA module 11 receives, via the I/O interface 12, the data transmitted by using an RDMA from the other information processing apparatus 1 (Step S41).

Then, the RDMA module 11 acquires the CR3 value from the received data (Step S42).

Then, the RDMA module 11 determines whether a physical address has not been allocated, by using the acquired CR3 value, to a virtual address that is specified by the data received, i.e., determines whether a page has not been allocated to a virtual address (Step S43). The flow of the process of determining whether a page is allocated will be described in detail later.

If a page has not been allocated (Yes at Step S43), the RDMA module 11 notifies the OS via the MMU 14 that a page fault has occurred. In response to the notification that a page fault has occurred, the OS performs an interrupt and then performs page allocation in which a physical address is allocated to a virtual address (Step S44). Then, the OS registers, in the page table 21, the association information in which the virtual address is associated with the physical address. When the page table 21 is updated, the RDMA module 11 receives an update notification from the MMU 14. Then, the RDMA module 11 acquires, from the page table 21, the association information in which the virtual address specified by the received data is associated with the physical address and then stores the association information in the page table cache 123.

If a page has been allocated (No at Step S43) or after the process at Step S44 has been performed, the RDMA module 11 performs address translation in which the virtual address specified by the received data is translated into the physical address (Step S45).

Then, the RDMA module 11 writes the received data into the acquired physical address in the user application area 23 (Step S46).

Then, the RDMA module 11 determines whether the writing of the data has been completed (Step S47). For example, by checking whether information indicating the last data is attached to the header of the received data, the RDMA module 11 determines whether the writing of the data has been completed.

If data that has not been written is present (No at Step S47), the RDMA module 11 returns to Step S45.

In contrast, the writing of the data has been completed (Yes at Step S47), the RDMA module 11 transmits an ACK to the information processing apparatus 1 that is the transmission source (Step S48).

Then, the RDMA module 11 transmits, to the application, a completion notification indicating that the data has been received by using the RDMA (Step S49).

The application receives, from the RDMA module 11, the completion notification indicating that the data has been received by using the RDMA (Step S50) and ends the process of receiving data performed by using the RDMA.

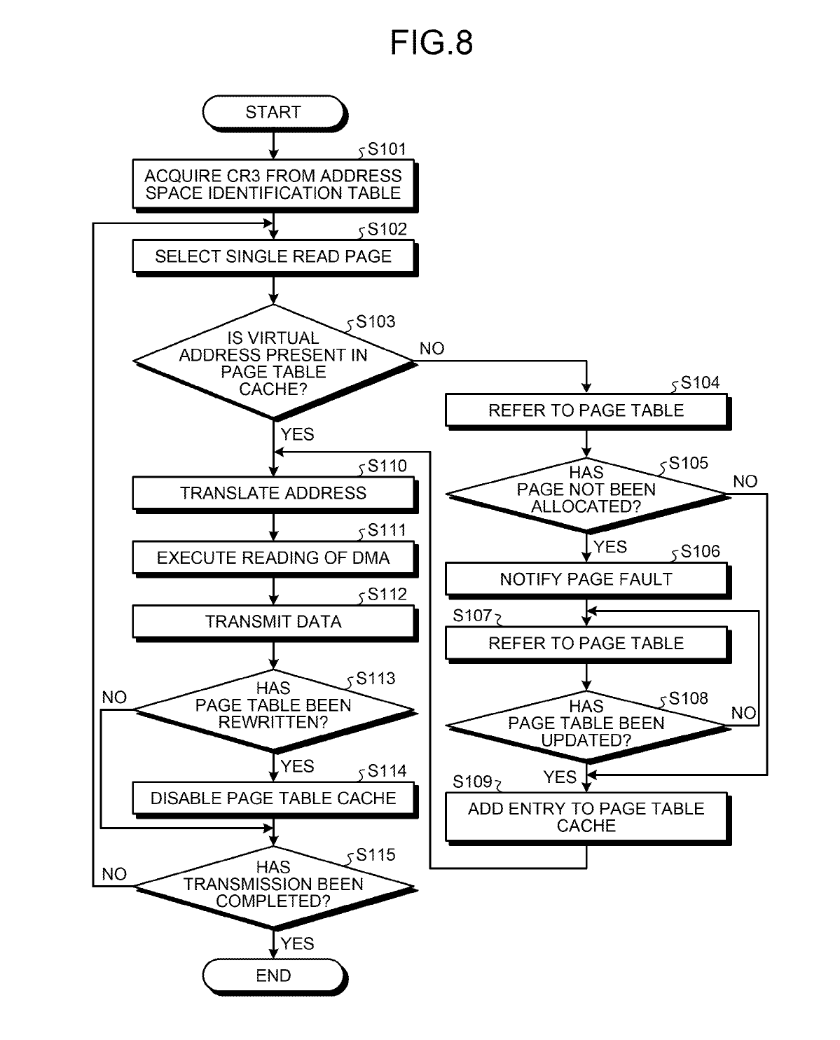

Furthermore, in the following, the flow of a data transmission process performed by the RDMA module 11 will be described in detail with reference to FIG. 8. FIG. 8 is a flowchart illustrating the flow of a data transmission process performed by an RDMA module.

The RDMA processing unit 111 transmits a translation request for an area specifier included in a transmission request for data to the specifier translation unit 125. The specifier translation unit 125 acquires, from the address space identification table 22, the CR3 value that is associated with the area specifier acquired from the RDMA processing unit 111 (Step S101). The RDMA processing unit 111 acquires, from the specifier translation unit 125, the CR3 value that is associated with the area specifier included in the transmission request for the data.

Then, the RDMA processing unit 111 selects a single read page that is read from the memory 20 (Step S102). Then, the RDMA processing unit 111 transmits, to the page fault detecting unit 121, an address translation request for a virtual address that indicates the selected read page.

The page fault detecting unit 121 receives the address translation request from the RDMA processing unit 111. Then, the page fault detecting unit 121 determines whether the virtual address specified by the address translation request is present in the page table cache 123 (Step S103). If the virtual address is present in the page table cache 123 (Yes at Step S103), the page fault detecting unit 121 proceeds to Step S110.

In contrast, if the virtual address is not present in the page table cache 123 (No at Step S103), the page fault detecting unit 121 instructs the cache control unit 122 to acquire information from the page table 21. The cache control unit 122 instructs the page table reading unit 124 to read a page table entry that is associated with the virtual address. The page table reading unit 124 refers to the page table 21 (Step S104). Then, if the page table entry associated with the virtual address is present in the page table 21, the page table reading unit 124 acquires the page table entry and adds the page table entry to the page table cache 123. Furthermore, the page table reading unit 124 transmits the physical address that is stored in the acquired page table entry to the page fault detecting unit 121.

The page fault detecting unit 121 determines whether a page has not been allocated in accordance with whether an entry associated with the virtual address is acquired from the page table reading unit 124 (Step S105). If a page has not been allocated (Yes at Step S105), the page fault detecting unit 121 transmits a notification request for a page fault to the page fault request receiving unit 144. Then, the page fault request receiving unit 144 notifies the processor core 13 of a page fault (Step S106).

Then, the page table reading unit 124 continues to refer to the page table 21 (Step S107). Then, the page table reading unit 124 determines whether the page table 21 to which the page table entry of the virtual address specified by the address translation request is added has been updated (Step S108). If the page table 21 has not been updated (No at Step S108), the page table reading unit 124 returns to Step S107.

In contrast, if the page table 21 has been updated (Yes at Step S108), the page table reading unit 124 adds the page table entry of the virtual address specified by the address translation request to the page table cache 123 (Step S109). Furthermore, if page allocation has already been performed (No at Step S105), the page table reading unit 124 also adds the page table entry of the virtual address specified by the address translation request to the page table cache 123 (Step S109). Furthermore, the page table reading unit 124 transmits the physical address associated with the virtual address to the page fault detecting unit 121.

Then, the page fault detecting unit 121 acquires a physical address that is associated with the virtual address specified by the address translation request and performs address translation (Step S110). Then, the page fault detecting unit 121 transmits the acquired physical address to the RDMA processing unit 111.

The RDMA processing unit 111 acquires, from the page fault detecting unit 121, the physical address as a response to the address translation request. Then, the RDMA processing unit 111 reads data, by using a DMA, from the acquired physical address in the user application area 23 (Step S111).

Then, the RDMA processing unit 111 transmits the read data to the information processing apparatus 1 that is the transmission destination of the data (Step S112).

The RDMA processing unit 111 determines whether the page table 21 has been rewritten (Step S113). If the page table 21 has been rewritten (Yes at Step S113), the RDMA processing unit 111 disables the target page table entry stored in the page table cache 123 (Step S114).

If the page table 21 has not been rewritten (No at Step S113) or after the process at Step S114 has been performed, the RDMA processing unit 111 determines whether the data transmission by using the RDMA has been completed (Step S115). If the data transmission by using the RDMA has not been completed (No at Step S115), the RDMA processing unit 111 returns to Step S102.

In contrast, if the data transmission by using the RDMA has been completed (Yes at Step S115), the RDMA processing unit 111 ends the data transmission process performed by using the RDMA.

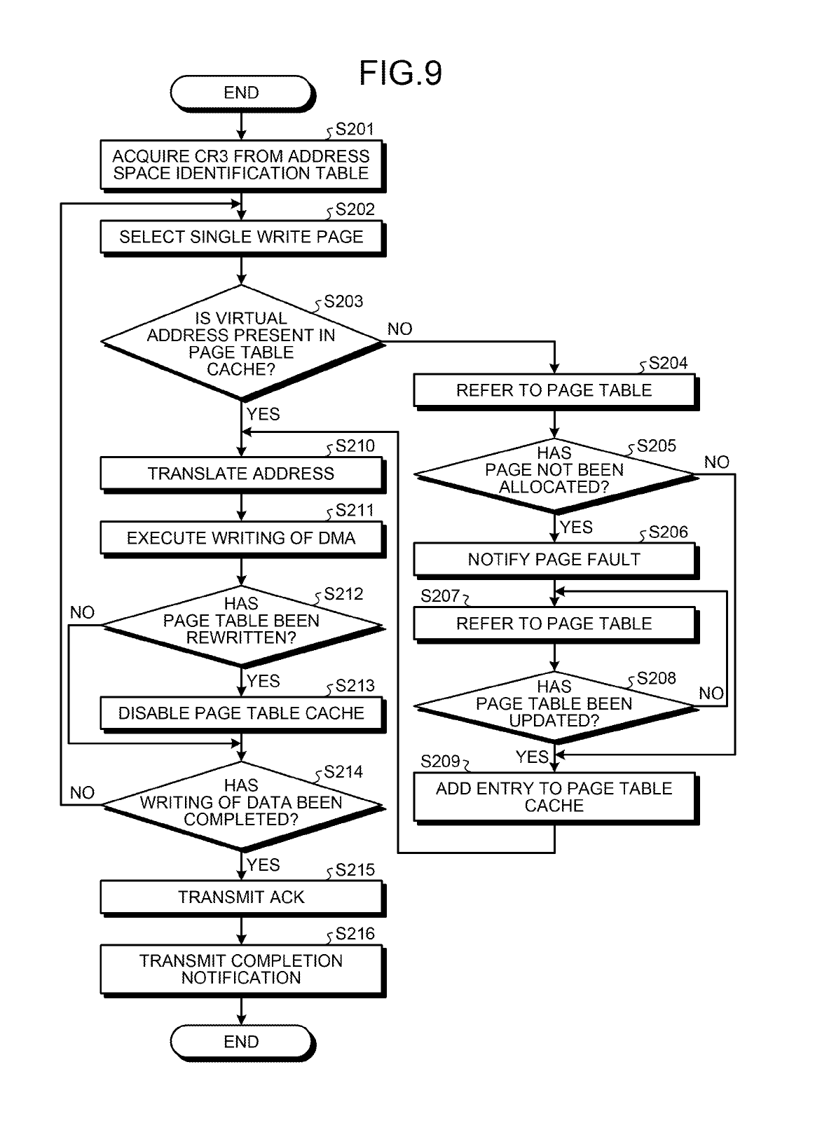

In the following, a data reception process performed by the RDMA module will be described in detail with reference to FIG. 9. FIG. 9 is a flowchart illustrating the flow of a data reception process performed by the RDMA module.

The RDMA processing unit 111 receives, via the I/O interface 12, the data transmitted from the other information processing apparatus 1 by using an RDMA. The RDMA processing unit 111 transmits a translation request for an area specifier included in the received data to the specifier translation unit 125. The specifier translation unit 125 acquires, from the address space identification table 22, the CR3 value that is associated with the area specifier acquired from, from the specifier translation unit 125, the RDMA processing unit 111 (Step S201). The RDMA processing unit 111 acquires the CR3 value that is associated with the area specifier included in the received.

Then, the RDMA processing unit 111 selects a single write page that is specified by the received data (Step S202). Then, the RDMA processing unit 111 transmits an address translation request for the virtual address that indicates the selected write page to the page fault detecting unit 121.

The page fault detecting unit 121 receives the address translation request from the RDMA processing unit 111. Then, the page fault detecting unit 121 determines whether the virtual address specified by the address translation request is present in the page table cache 123 (Step S203). If the virtual address is present in the page table cache 123 (Yes at Step S203), the page fault detecting unit 121 proceeds to Step S210.

In contrast, if the virtual address is not present in the page table cache 123 (No at Step S203), the page fault detecting unit 121 instructs the cache control unit 122 to acquire the information from the page table 21. The cache control unit 122 instructs the page table reading unit 124 to read the page table entry that is associated with the virtual address. The page table reading unit 124 refers to the page table 21 (Step S204). Then, if the page table entry associated with the virtual address is present in the page table 21, the page table reading unit 124 acquires the page table entry and adds the page table entry to the page table cache 123. Furthermore, the page table reading unit 124 transmits the physical address that is stored in the acquired page table entry to the page fault detecting unit 121.

The page fault detecting unit 121 determines whether a page has not been allocated in accordance with whether an entry associated with the virtual address is received from the page table reading unit 124 (Step S205). If a page has not been allocated (Yes at Step S205), the page fault detecting unit 121 transmits a notification request for a page fault to the page fault request receiving unit 144. Then, the page fault request receiving unit 144 notifies the processor core 13 of the page fault (Step S206).

Then, the page table reading unit 124 continues to refer to the page table 21 (Step S207). Then, the page table reading unit 124 determines whether the page table entry of the virtual address specified by the address translation request is added and the page table 21 has been updated (Step S208). If the page table 21 has not been updated (No at Step S208), the page table reading unit 124 returns to Step 5207.

In contrast, if the page table 21 has been updated (Yes at Step S208), the page table reading unit 124 adds the page table entry of the virtual address that is specified by the address translation request to the page table cache 123 (Step S209). Furthermore, if page allocation has already been performed (No at Step S205), the page table reading unit 124 also adds page table entry of the virtual address that is specified by the address translation request to the page table cache 123 (Step S209). Furthermore, the page table reading unit 124 transmits the physical address associated with the virtual address to the page fault detecting unit 121.

Then, the page fault detecting unit 121 acquires the physical address that is associated with the virtual address specified by the address translation request and performs the address translation (Step S210). Thereafter, the page fault detecting unit 121 transmits the acquired physical address to the RDMA processing unit 111.

The RDMA processing unit 111 acquires, from the page fault detecting unit 121, the physical address as a response to the address translation request. Then, the RDMA processing unit 111 writes data into the acquired physical address in the user application area 23 by using the DMA (Step S211).

Then, the RDMA processing unit 111 determines whether the page table 21 has been rewritten (Step S212). If the page table 21 has been rewritten (Yes at Step S212), the RDMA processing unit 111 disables the target page table entry in the page table cache 123 (Step S213).

If the page table 21 has not been rewritten (No at Step S212) or after the process at Step S214 has been performed, the RDMA processing unit 111 determines whether the writing of the data has been completed (Step S214). If the writing of the data has not been completed (No at Step S214), the RDMA processing unit 111 returns to Step S202.

In contrast, if the writing of the data has been completed (Yes at Step S214), the RDMA processing unit 111 transmits an ACK to the information processing apparatus 1 that is the transmission source of the data (Step S215).

Then, the RDMA processing unit 111 transmits a completion notification to the processor core 13 indicating that the data has been received by using the RDMA (Step S216) and ends the process of receiving the data performed by using the RDMA.

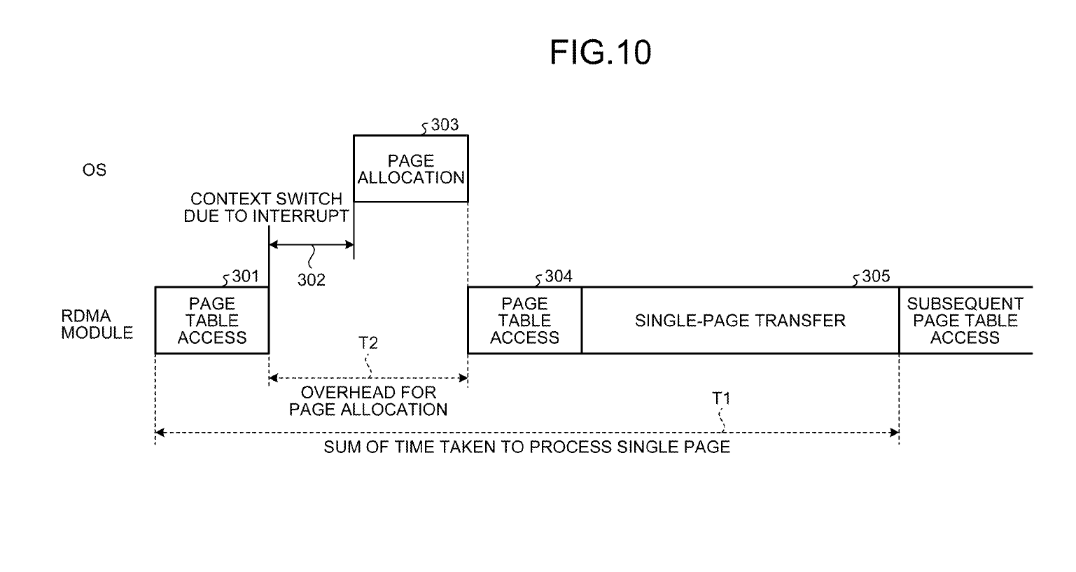

In the following, an overhead due to page allocation when data transfer is performed in the information processing apparatus 1 according to the first embodiment by using an RDMA will be described with reference to FIG. 10. FIG. 10 is a schematic diagram illustrating overhead due to page allocation when data is transferred by using the RDMA according to a first embodiment. In FIG. 10, the elapse of time is represented as a step moves to the right side. Furthermore, the processes performed in data transfer by using an RDMA illustrated in the blocks in FIG. 10 represents that the subject illustrated on the left side performs the process. Examples of the processes executed by the data transfer by using the RDMA includes a process of referring to the page table cache 123, referring to the page table 21, detecting a page that has not been allocated, executing page allocation, and performing the data transfer. FIG. 10 illustrates each of the processes, as an example, by using a process that is performed when a page has not been allocated.

The RDMA module 11 refers to the page table cache 123, refers to the page table 21, and then detects a page that has not been allocated. The processes of referring to the page table cache 123, referring to the page table 21, and detecting a page that has not been allocated corresponds to an example of the processes performed in a page table access 301.

If a page fault occurs, an interrupt with respect to the process performed on the OS by the processor core 13 occurs and a context switch is performed. The time taken to perform this process is represented by an elapsed time 302.

Thereafter, a page allocation with respect to a virtual address that is used when the data transfer is performed by the OS using an RDMA. This process mentioned here corresponds to the process indicated by a page allocation 303.

When a page is allocated, the RDMA module 11 acquires, from the page table 21, a page table entry that is associated with the virtual address used for the data transfer that is performed by using an RDMA. Then, the RDMA module 11 acquires the physical address that is stored in the acquired page table entry. This process corresponds to the process indicated by a page table access 304.

Then, the RDMA processing unit 111 performs the data transfer for one page by using the acquired physical address. This process corresponds to single-page transfer 305.

The process described above is a process performed when single page data is transferred by the RDMA processing unit 111; however, the RDMA processing unit 111 repeats the process described above until the data transfer has been completed.

In this case, time T1 that is the sum of the time taken for the page table access 301, the elapsed time 302, the page allocation 303, the page table access 304, and the single-page transfer 305 corresponds to the time taken to process a single page.

Furthermore, time T2 that is the sum of the time taken for the elapsed time 302 and the page allocation 303 corresponds to the time taken for the overhead of the page allocation.

At this point, the time taken for the page table accesses 301 and 304 is assumed to be about 300 ns for each time. Furthermore, if the transfer speed is set to 10 GB/s and the page size is set to 4 MB, the time taken for the single-page transfer 305 is assumed to be 400 μs. Furthermore, the time taken for an interrupt is assumed to be about 5 μs. Furthermore, if the condition is 10000 cycle/2 GHz, the time taken for the context switch is assumed to be 5 μs. Furthermore, the time taken for the page allocation 303 is assumed to be about 10 μs.

Namely, the overhead due to the page allocation is 20.3 μs/420.6 μs×100=4.8%. However, if a page has already been allocated, a page fault does not occur; therefore, overhead with about 5% does not always occur.

In this way, although the performance varies about 5%, it is possible to reduce the load occurring due to a lock when a memory area is registered and thus the overall throughput can be improved. Furthermore, the area that is reserved in a memory for the data transfer performed by using an RDMA is only an area that is to be used. In this way, the information processing apparatus according to the first embodiment can effectively use the memory resources while reducing the processing load.

Furthermore, in the information processing apparatus according to the first embodiment, because a lock for an RDMA is not performed, it is possible to release a page, in a memory, that is not used for a long time. Consequently, in the information processing apparatus according to the first embodiment, it is possible to increase the number of processes that can be started up. For example, a description will be given of a case in which the number of processor cores is 16, the size of the mounted memory is 64 GB, and an area of 4 GB is registered for each process. If a lock is performed, only the processes of 64 GB/4 GB=16 processes can be started up. In contrast, in the information processing apparatus according to the first embodiment, a lock is not needed, a page out can be performed on an area in which a process is not being performed. Consequently, in the information processing apparatus according to the first embodiment, at least 16 processes, which is the same number of the processor cores, need to be reserved in a physical memory and, if a memory that can be used is present, 16 processes or more processes can be started up.

Furthermore, a description has been given of an example case of a processor having x86 architecture; however, the type of processors is not limited thereto as long as the same format is used for the page table 21, the TLB 142, and the page table cache 123.

Modification

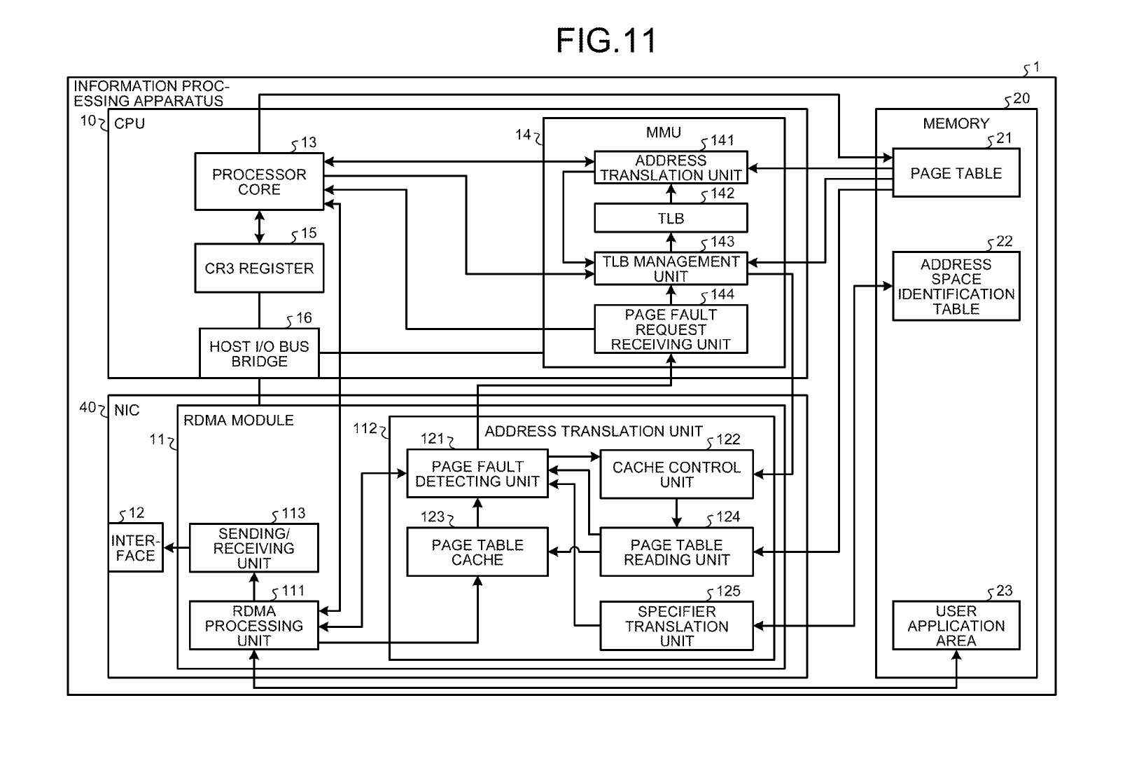

In the following, a modification of the first embodiment will be described with reference to FIG. 11. FIG. 11 is a block diagram illustrating an information processing apparatus according to a modification of the first embodiment. With the information processing apparatus according to the modification, the function of the data transfer performed by using an RDMA is installed in a unit other than the CPU.

The information processing apparatus 1 includes the CPU 10, the memory 20, and a network interface controller (NIC) 40.

The CPU 10 includes the processor core 13, the MMU 14, the CR3 register 15, and a host I/O bus bridge 16. The NIC 40 includes the RDMA module 11 and the I/O interface 12.

Each of the functioning units in the CPU 10 communicates with each of the functioning units in the RDMA module 11 in the NIC 40 via the host I/O bus bridge. Then, each of the functioning units in the CPU 10 and the NIC 40 illustrated in FIG. 11 performs the same operation as that performed by each of the unit having the same reference numerals illustrated in FIG. 1 described in the first embodiment.

As described above, the same effect can be obtained even if an RDMA module is installed outside the CPU.

Furthermore, in the modification, the RDMA module is installed in the NIC; however, the configuration is not limited thereto. The RDMA module may also be installed in another member as long as the member can transfer an RDMA to the other information processing apparatus. For example, the RDMA module may also be installed in a host bus adapter (HBA) or the like and data transfer using an RDMA may also be performed between the HBA of the other information processing apparatus.

Furthermore, in order to effectively use the conventional configuration in which a processor core communicates with an MMU, in the first embodiment and the modification, the RDMA module communicates with the processor core via the MMU. With this configuration, the function described above can be added to the existing configuration by only making a small change and thus the manufacturing cost can be suppressed. However, if the existing configuration does not need to be used, the processor core and the RDMA module may also directly communicate with each other without using the MMU. In such a case, the page fault request receiving unit may also be omitted.

### [b] Second Embodiment

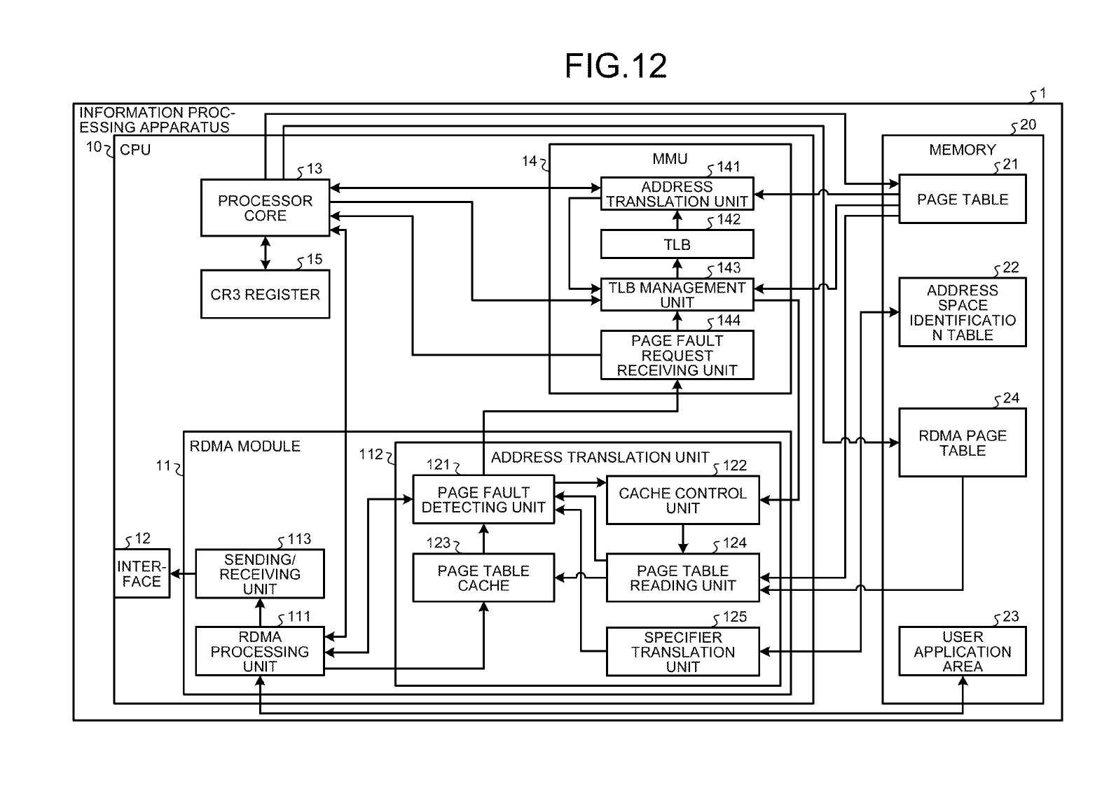

FIG. 12 is a block diagram illustrating an information processing apparatus according to a second embodiment. The information processing apparatus according to the second embodiment differs from the first embodiment in that, in data transfer performed by using an RDMA, it is possible to select either one of methods between a method of locking an area in a memory and a method of performing page allocation without locking. In a description below, descriptions of components having the same functions as those performed in the first embodiment will be omitted.

When data transfer using an RDMA is performed, the processor core 13 receives, from an operator, an input indicating whether a page lock is used.

Then, the processor core 13 notifies the RDMA module 11 of the instruction received from the operator. Specifically, the processor core 13 notifies, for example, the RDMA processing unit 111 of the instruction received from the operator.

Furthermore, if a page lock is used, the RDMA module 11 reserves a user area for an RDMA in the memory 20 by using the OS and the processor core 13 locks the area by using the driver of the RDMA module 11. Furthermore, the processor core 13 creates an RDMA page table 24 that is associated with the area locked by using the driver of the RDMA module 11.

The RDMA page table 24 may also use the format that is different from that of the page table 21.

If the page lock is not used, each of the units in the RDMA module 11 performs the same operation as that performed in the first embodiment.

If the page lock is used and if a page table entry that is associated with specified the virtual address is not present in the page table cache 123, the page table reading unit 124 receives an acquisition request for the page table entry from the cache control unit 122. Then, the page table reading unit 124 accesses the RDMA page table 24 and acquires the page table entry associated with the virtual address. In this case, because the page to be used has already been registered, the page table reading unit 124 can acquire the page table entry that is associated with the virtual address.

Then, the page table reading unit 124 adds the acquired page table entry to the page table cache 123. Furthermore, the page table reading unit 124 transmits the physical address included in the acquired page table entry to the page fault detecting unit 121.

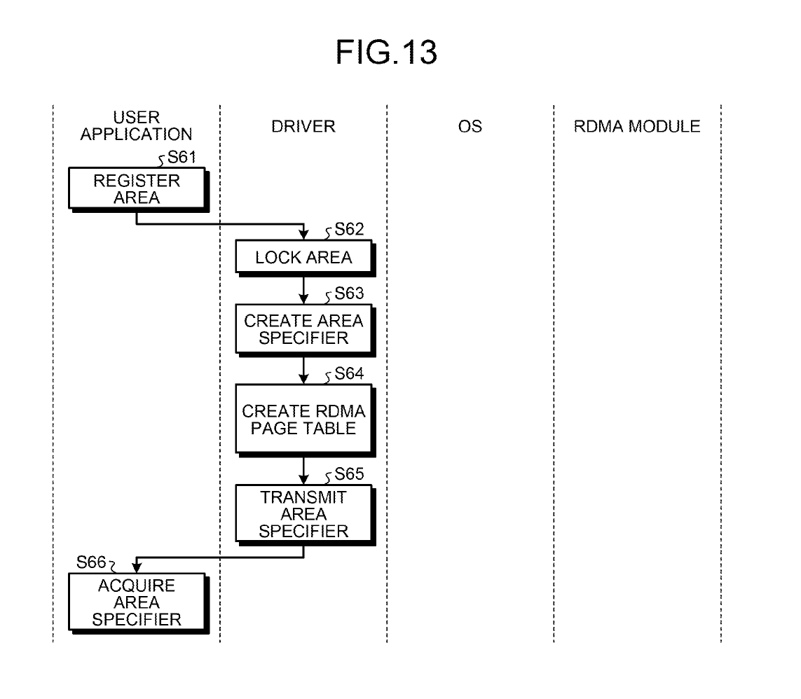

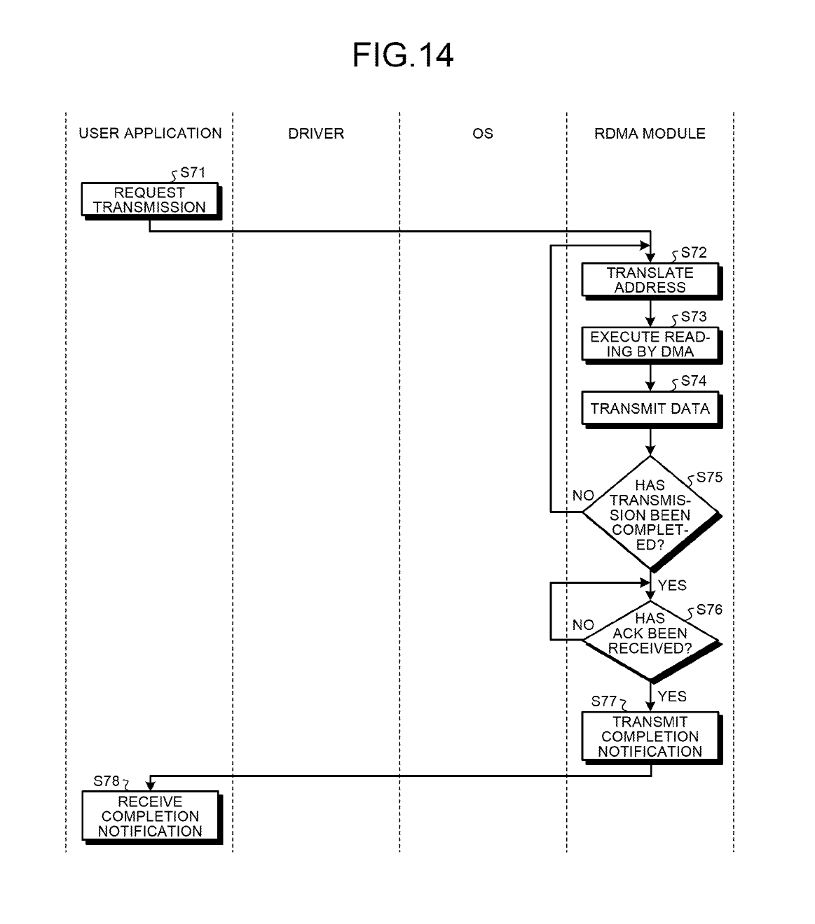

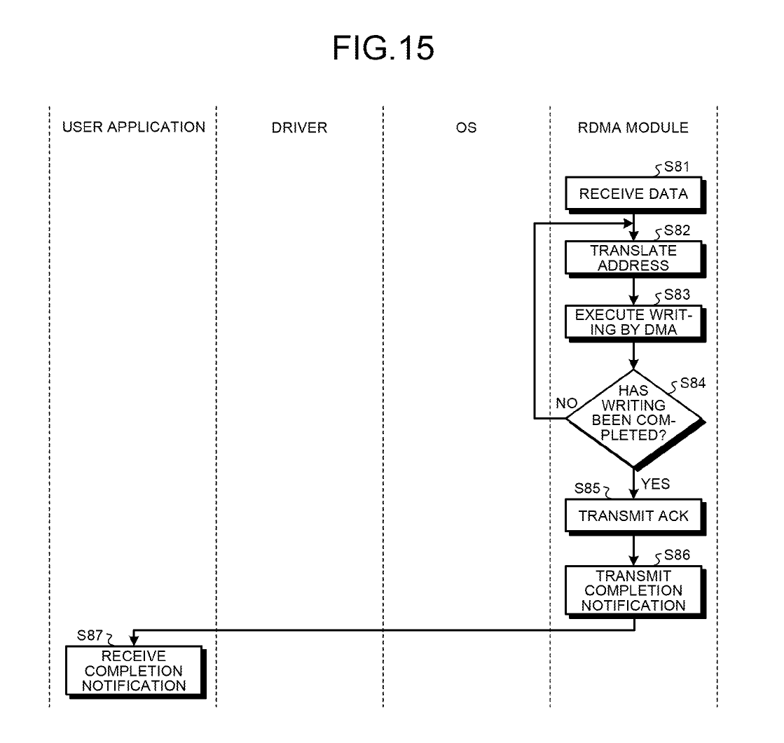

In the following, the flow of the area registration process performed when a page lock is used will be described with reference to FIG. 13. FIG. 13 is a flowchart illustrating the flow of an area registration process performed when a page lock is used. In FIG. 13, for convenience, similarly to FIG. 5, the software executed by the processor core 13 is represented as the subject that performs the operation. Namely, in practice, the operation subject as hardware that is associated with each piece of software is the processor core 13. The above described settings are also applied to the settings illustrated in FIGS. 14 and FIG. 15, which will be described later.

The user application instructs to perform area registration (Step S61).

In response to the instruction from the user application, the driver locks an area in the memory 20 (Step S62).

Then, the driver creates an area specifier that is associated with the locked area (Step S63).

Then, the driver creates the RDMA page table 24 (Step S64).

Then, the driver transmits the area specifier to the user application (Step S65).

The user application acquires the area specifier from the driver (Step S66).

At this point, in the area registration process that is performed when a page lock illustrated in FIG. 13 is used, no process is performed on the OS and the RDMA module.

In the following, the flow of a process performed by the information processing apparatus 1 that performs RDMA transmission by using a page lock will be described with reference to FIG. 14. FIG. 14 is a flowchart illustrating the flow of a process performed by the information processing apparatus that executes RDMA transmission by using a page lock.

The user application transmits a transmission request performed by using an RDMA to the RDMA module 11 (Step S71).

The RDMA module 11 receives the transmission request performed by using the RDMA from the user application. Then, the RDMA module 11 acquires an area specifier of the user application area 23 that is added to the transmission request. Then, by using the acquired area specifier, the RDMA module 11 acquires, from the page table cache 123 or the page table 21, the association information in which the physical address is associated with the virtual address that is specified by the transmission request and then performs the address translation (Step S72).

Then, the RDMA module 11 reads the data that is stored in the acquired physical address in the user application area 23. Namely, the RDMA module 11 executes DMA to read the data (Step S73).

Thereafter, the RDMA module 11 transmits, by using the RDMA, the read data to the information processing apparatus 1 that is the transmission destination (Step S74).

Then, the RDMA module 11 determines whether the transmission of the data performed by using the RDMA has been completed (Step S75). If data that has not yet been transmitted is present (No at Step S75), the RDMA module 11 returns to Step S72.

In contrast, if data transmission has been completed (Yes at Step S75), the RDMA module 11 determines whether an ACK has been received from the information processing apparatus 1 that is the transmission destination (Step S76). If an ACK has not been received (No at Step S76), the RDMA module 11 waits until an ACK is received.

In contrast, if an ACK has been received (Yes at Step S76), the RDMA module 11 transmits a completion notification of the RDMA transmission to the application (Step S77).

The application receives the completion notification of the RDMA transmission sent from the RDMA module 11 (Step S78) and ends the process of the RDMA transmission.

In the following, the flow of a process performed by the information processing apparatus 1 that receives data by using an RDMA using a page lock will be described with reference to FIG. 15. FIG. 15 is a flowchart illustrating the flow of a process performed by the information processing apparatus that receives, by using a page lock, data by using an RDMA.

The RDMA module 11 receives, via the I/O interface 12, the data that is transmitted from the other information processing apparatus 1 by using an RDMA (Step S81).

Then, the RDMA module 11 acquires an area specifier from the received data. Then, the RDMA module 11 acquires, by using the acquired area specifier from the page table cache 123 or the page table 21, the association information in which the physical address is associated with the virtual address that is specified by the received data and performs address translation (Step S82).

Thereafter, the RDMA module 11 writes the received data into the acquired physical address in the user application area 23. Namely, the RDMA module 11 executes DMA to write the received data (Step S83).

Then, the RDMA module 11 determines whether the writing of the data has been completed (Step S84).

If data that has not been written is present (No at Step S84), the RDMA module 11 returns to Step S82.

In contrast, if the writing of the data has been completed (Yes at Step S84), the RDMA module 11 transmits an ACK to the information processing apparatus 1 that is the transmission source (Step S85).

Then, the RDMA module 11 transmits a completion notification to the application indicating that the data has been received by using the RDMA (Step S86).

The application receives the completion notification from the RDMA module 11 indicating that the data has been received by using the RDMA (Step S87) and then ends the process of receiving the data by using the RDMA.

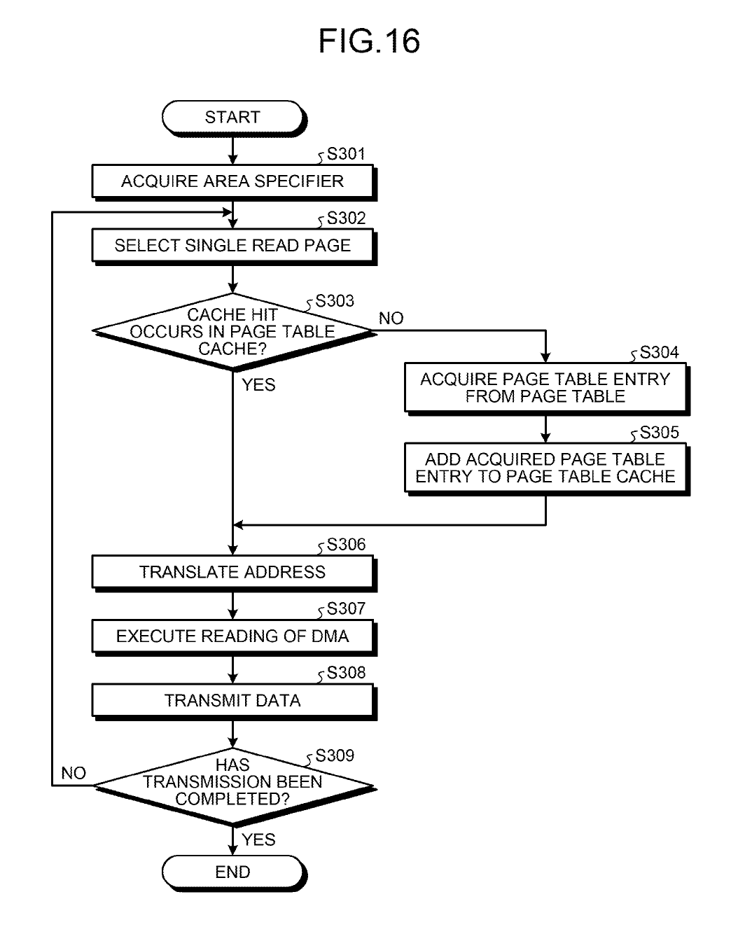

Furthermore, in the following, the flow of a data transmission process performed by the RDMA module 11 using a page lock will be described in detail with reference to FIG. 16. FIG. 16 is a flowchart illustrating the flow of a data transmission process performed by the RDMA module when a page lock is used.

The RDMA processing unit 111 transmits, to the specifier translation unit 125, a translation request for an area specifier that is included in the transmission request for data. The specifier translation unit 125 acquires the area specifier from the RDMA processing unit 111 (Step S301).

Then, the RDMA processing unit 111 selects a single read page that is read from the memory 20 (Step S302). Then, the RDMA processing unit 111 transmits an address translation request for a virtual address that indicates the selected read page to the page fault detecting unit 121.

The page fault detecting unit 121 receives the address translation request from the RDMA processing unit 111. Then, the page fault detecting unit 121 determines whether the virtual address specified by the address translation request is present in the page table cache 123 (Step S303). If the virtual address is present in the page table cache 123 (Yes at Step S303), the page fault detecting unit 121 proceeds to Step S306.

In contrast, if the virtual address is not present in the page table cache 123 (No at Step S303), the page fault detecting unit 121 instructs the cache control unit 122 to acquire information from the page table 21. The cache control unit 122 instructs the page table reading unit 124 to read the page table entry that is associated with the virtual address. The page table reading unit 124 acquires the page table entry that is associated from the virtual address from the page table (Step S304).

Then, the page table reading unit 124 adds the acquired page table entry to the page table cache 123 (Step S305). Furthermore, the page table reading unit 124 transmits the physical address that is stored in the acquired page table entry to the page fault detecting unit 121.

The page fault detecting unit 121 acquires the physical address that is associated with the virtual address specified by the address translation request and performs the address translation (Step S306). Then, the page fault detecting unit 121 checks whether the acquired physical address is associated with the area specifier. Then, the page fault detecting unit 121 transmits the acquired physical address to the RDMA processing unit 111.

The RDMA processing unit 111 receives the physical address from the page fault detecting unit 121 as a response to the address translation request. Then, the RDMA processing unit 111 reads data by using a DMA from the acquired physical address in the user application area 23 (Step S307).

Then, the RDMA processing unit 111 transmits the read data to the information processing apparatus 1 that is the transmission destination of the data (Step S308).

Thereafter, the RDMA processing unit 111 determines whether the data transmission by using the RDMA has been completed (Step S309). If the data transmission by using the RDMA has not been completed (No at Step S309), the RDMA processing unit 111 returns to Step S302.

In contrast, if the data transmission by using the RDMA has been completed (Yes at Step S309), the RDMA processing unit 111 ends the process of the data transmission performed by using the RDMA.

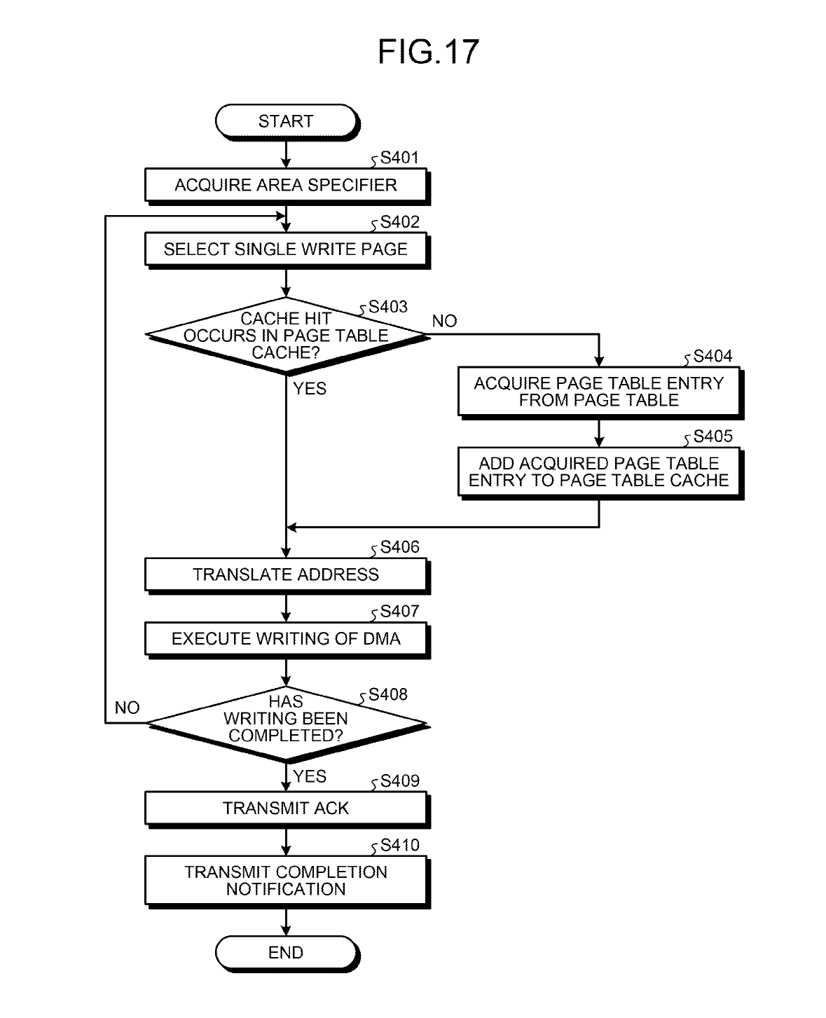

In the following, a process of receiving data by the RDMA module 11 when a page lock is used will be described in detail with reference to FIG. 17. FIG. 17 is a flowchart illustrating the flow of a process of receiving data performed by the RDMA module when a page lock is used.

The RDMA processing unit 111 receives, via the I/O interface 12, the data that is transmitted from the other information processing apparatus 1 by using an RDMA. The RDMA processing unit 111 acquires the area specifier that is included in the received data (Step S401).

Then, the RDMA processing unit 111 selects a single write page that is specified by the received data (Step S402). Then, the RDMA processing unit 111 transmits, to the page fault detecting unit 121, the address translation request for the virtual address that indicates the selected write page.

The page fault detecting unit 121 receives the address translation request from the RDMA processing unit 111. Then, the page fault detecting unit 121 determines whether the virtual address specified by the address translation request is present in the page table cache 123 (Step S403). If the virtual address is present in the page table cache 123 (Yes at Step S403), the page fault detecting unit 121 proceeds to Step S406.

In contrast, if the virtual address is not present in the page table cache 123 (No at Step S403), the page fault detecting unit 121 instructs the cache control unit 122 to acquire the information from the page table 21. The cache control unit 122 instructs the page table reading unit 124 to read the page table entry that is associated with the virtual address. The page table reading unit 124 acquires, from the page table 21, the page table entry in the virtual address that is specified by the address translation request (Step S404).

Then, the page table reading unit 124 adds the acquired page table entry to the page table cache 123 (Step S405). Furthermore, the page table reading unit 124 transmits the physical address that is associated with the virtual address to the page fault detecting unit 121.

The page fault detecting unit 121 acquires the physical address that is associated with the virtual address specified by the address translation request and performs the address translation (Step S406). Then, the page fault detecting unit 121 checks whether the acquired physical address is associated with the area specifier. Then, the page fault detecting unit 121 transmits the acquired physical address to the RDMA processing unit 111.

The RDMA processing unit 111 acquires the physical address from the page fault detecting unit 121 as a response to the address translation request. Then, the RDMA processing unit 111 writes data, by using a DMA, with respect to the acquired physical address in the user application area 23 (Step S407).

Then, the RDMA processing unit 111 determines whether the writing of the data has been completed (Step S408). If the writing of the data has not been completed (No at Step S408), the RDMA processing unit 111 returns to Step S402.

In contrast, if the writing of the data has been completed (Yes at Step S408), the RDMA processing unit 111 transmits an ACK to the information processing apparatus 1 that is the transmission source of the data (Step S409).

Then, the RDMA processing unit 111 transmits a completion notification to the processor core 13 indicating that the data has been received by using the RDMA (Step S410) and ends the process of receiving the data by using the RDMA.

As described above, the information processing apparatus according to the second embodiment can select either one of the methods between the method of locking a page when data transfer is performed by using an RDMA and the method of allocating a page every time data transfer is performed. Consequently, the method of locking a page can be selected if the overhead needs to be reduced, whereas the method of allocating a page every time data transfer is performed can be selected if the memory resource is reserved in order to increase the number of processes. Consequently, it is possible to select a method of data transfer performed by using an RDMA in accordance with the type of applications or in accordance with the desired performance; therefore, it is possible to more flexibly perform data transfer by using an RDMA.

According to an aspect of an embodiment of arithmetic processing apparatus, the information processing apparatus, and the control method of the arithmetic processing apparatus disclosed in the present invention, an advantage is provided in that the memory resources can be effectively used while the processing load is reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic processing apparatus comprising:
an arithmetic processing unit that executes an arithmetic processing, that allocates an area of first main storage with respect to a process of reading data and writing data, and that creates allocation information indicating the allocated area;
a memory management unit that performs, by receiving a use request for the first main storage from the arithmetic processing unit, a data management process on the first main storage by using a first area that is indicated by the allocation information; and
a data transfer control unit that requests, by receiving an instruction to perform a data transfer process between the first main storage and a second main storage from the arithmetic processing unit, when an area for the data transfer has not been allocated, the arithmetic processing unit to execute the allocation and that performs the data transfer process by using a second area indicated by the allocation information that is created by the arithmetic processing unit.

2. The arithmetic processing apparatus according to claim 1, wherein
the memory management unit translates a first virtual address that is included in the use request to a first physical address in the first area, based on address association information that is stored in the allocation information and that indicates association between a virtual address and a physical address, and performs the data management process on the first main storage by using the first physical address, and
the data transfer control unit translates a second virtual address that is included in the instruction to perform the data transfer process to a second physical address, based on the address association information stored in the allocation information, and performs the data transfer process by using the second physical address.

3. The arithmetic processing apparatus according to claim 2, wherein
when association information indicating the association between the first virtual address and the first physical address is not present in the address association information, the memory management unit requests the arithmetic processing unit to execute allocation of the first area and registers, as the first physical address and in the address association information, the physical address in the first area allocated by the arithmetic processing unit, and
when association information indicating the association between the second virtual address and the second physical address is not present in the address association information, the data transfer control unit determines that the area for the data transfer has not been allocated, requests the arithmetic processing unit to execute allocation of the second area, and registers, as the second physical address and in the address association information, the physical address in the second area allocated by the arithmetic processing unit.

4. The arithmetic processing apparatus according to claim 2, wherein the data transfer control unit includes a cache that stores therein association information between the second virtual address and the second physical address indicated by the address association information, updates, when the association between the second virtual address and the second physical address indicated by the address association information is updated, the association information stored in the cache, and translates, by using the association information stored in the cache, the second virtual address to the second physical address.

5. The arithmetic processing apparatus according to claim 1, wherein
when the area for the data transfer has not been allocated, the data transfer control unit notifies the memory management unit that the area has not been allocated, and
the memory management unit requests, by receiving the notification from the data transfer control unit indicating that the area has not been allocated, the arithmetic processing unit to execute allocation of the second area.

6. An information processing apparatus comprising:
an arithmetic processing apparatus;
main storage; and
a data transfer unit, wherein
the arithmetic processing apparatus includes
an arithmetic processing unit that executes an arithmetic processing, that allocates an area of first main storage with respect to a process of reading data and writing data, that creates allocation information indicating the allocated area, and that stores the allocation information in the main storage, and
a memory management unit that performs, by receiving a use request for the first main storage from the arithmetic processing unit, a data management process on the first main storage by using a first area indicated by the allocation information stored in the first main storage, and
the data transfer unit requests, by receiving an instruction to perform a data transfer process between the first main storage and a second main storage from the arithmetic processing unit, when an area for the data transfer has not been allocated, the arithmetic processing unit to execute the allocation, and performs the data transfer process by using a second area indicated by the allocation information that is stored in the first main storage by the arithmetic processing unit.

7. The information processing apparatus according to claim 6, wherein
the main storage stores therein the allocation information in which address association information indicating the association between a virtual address and a physical address is stored,
the memory management unit translates, by using the address association information, a first virtual address included in the use request to a first physical address in the first area and performs the data management process on the main storage by using the first physical address, and
the data transfer control device translates, on the basis of the address association information, a second virtual address that is included in an instruction to perform the data transfer process to a second physical address, and performs the data transfer process by using the second physical address.

8. A control method of an arithmetic processing apparatus that includes an arithmetic processing unit, the control method comprising:
performing, when the arithmetic processing unit issues a use request for a first main storage, a data management process on first main storage by using a first area indicated by allocation information that indicates an area that is allocated in the first main storage by the arithmetic processing unit, and
requesting, when the arithmetic processing apparatus instructs a data transfer process between the first main storage and a second main storage and when an area for the data transfer has not been allocated, the arithmetic processing unit to execute the allocation and performing the data transfer process by using a second area indicated by the allocation information that is created by the arithmetic processing unit.
